(19) United States
(12) Patent Application Publication
(10) Pub. No.: US 2014/0177555 A1
(43) Pub. Date: Jun. 26, 2014

(54) INTER-ENB COORDINATION METHODS TO SUPPORT INTER-ENB CARRIER AGGREGATION FOR LTE-ADVANCED

(71) Applicant: Samsung Electronics Co., LTD, Suwon-si (KR)

(72) Inventors: Boon Loong Ng, Dallas, TX (US); Young-Han Nam, Plano, TX (US); Thomas David Novlan, Dallas, TX (US)

(73) Assignee: Samsung Electronics Co., LTD, Suwon-si (KR)

(21) Appl. No.: 14/109,600

(22) Filed: Dec. 17, 2013

Related U.S. Application Data
(60) Provisional application No. 61/745,397, filed on Dec. 21, 2012.

(51) Int. Cl. H04W 72/04

(52) U.S. Cl. CPC H04W 72/0413
USPC 370/329

(57) ABSTRACT

Various inter-eNodeB (eNB) coordination methods and systems are disclosed. For example, in one approach, a user equipment (UE) configured to communicate with a plurality of eNodeBs (eNBs). Each of the plurality of eNBs are configured to receive and transmit coordination information from other eNBs identifying how uplink control information (UCI) data of the UE should be transmitted. The UE includes processing circuitry. When the UE is configured with more than one serving cell for inter-eNodeB (eNB) Carrier Aggregation (CA), the processing circuitry is not configured for simultaneous physical uplink shared channel (PUSCH) and physical uplink control channel (PUCCH) transmissions.

### CROSS-REFERENCE TO RELATED APPLICATION AND PRIORITY CLAIM

This application claims priority under 35 U.S.C. §119(e) to U.S. Provisional Patent Application No. 61/745,397 filed on Dec. 21, 2012. The above-identified provisional patent application is hereby incorporated by reference in its entirety.

### TECHNICAL FIELD

This application relates generally to wireless communication systems and, more specifically, to a system and method for providing inter-site carrier aggregation (CA).

### BACKGROUND

In Release 10 (Rel-10) of the Long Term Evolution (LTE) wireless standard, Carrier Aggregation (CA) was introduced to increase the peak throughput of user equipment (UE). Inter-site CA deployment scenarios are supported in Rel-10, for example, between a macro site (on a first carrier frequency F1) and a pico site (on a second carrier frequency F2). In Rel-10, an assumption was made that fast fiber connections between the macro site and the pico site can send data and L1 control information from the macro site to the pico site and vice versa with very small latency in order to accommodate stringent coordination requirements between the sites. However, the stringent coordination requirements may not be met in many actual installations.

### SUMMARY

This disclosure provides a method and system for coordinating transmission of uplink control information (UCI) data through a wireless communication network.

In a first embodiment, a system for use in a wireless network includes a user equipment (UE) configured to communicate with a plurality of eNodeBs (eNBs). Each of the plurality of eNBs are configured to receive and transmit coordination information from other eNBs identifying how uplink control information (UCI) data of the UE should be transmitted. The UE includes processing circuitry. When the UE is configured with more than one serving cell for inter-eNodeB (eNB) Carrier Aggregation (CA), the processing circuitry is not configured for simultaneous physical uplink shared channel (PUSCH) and physical uplink control channel (PUCCH) transmissions.

In a second embodiment, a method of setting up a user equipment (UE) in an inter-eNodeB (eNB) Carrier Aggregation (CA) system includes not configuring, by an eNB, the UE for simultaneous physical uplink shared channel (PUSCH) and physical uplink control channel (PUCCH) transmissions. The method also includes transmitting coordination information from at least one eNB to at least one other eNB so that the UE is not configured for simultaneous PUCCH and PUSCH transmissions before or when the UE is configured with inter-eNB CA.

In a third embodiment, a system for use in a wireless network includes an eNodeB (eNB) configured to communicate with at least one user equipment (UE) and to receive and transmit coordination information identifying how channel state information (CSI) should be transmitted. The eNB includes processing circuitry. The processing circuitry is configured to receive control information including a partitioning of subframes so that no two aperiodic CSI report requests from two or more eNBs are sent to the UE in the same subframe.

In a fourth embodiment, a method of setting up an eNodeB (eNB) in an inter-eNB Carrier Aggregation (CA) system includes transmitting and receiving control information by the eNB, wherein the control information includes a partitioning of subframes so that no two aperiodic CSI report requests from two or more eNBs are sent to the UE in the same subframe.

In a fifth embodiment, a system for use in a wireless network includes a first eNodeB (eNB) configured to participate with at least a second eNB in inter-eNB Carrier Aggregation (CA). The first eNB is configured to receive coordination information identifying how hybrid automatic repeat requests and acknowledgments (HARQ-ACKs) should be transmitted by the UE. The first eNB includes processing circuitry. The processing circuitry is configured to coordinate a first set of eNB subframe indices with at least a second set of eNB subframe indices such that the set of subframe indices for HARQ-ACK receptions by the first eNB does not overlap with the set of subframe indices for HARQ-ACK receptions by the second eNB.

In a sixth embodiment, a method of setting up an eNodeB (eNB) in an inter-eNB Carrier Aggregation (CA) system includes transmitting and receiving control information by the eNB, wherein the control information includes coordinating information coordinating a first set of eNB subframe indices with at least a second set of eNB subframe indices such that the first set of subframe indices for HARQ-ACK receptions by the first eNB does not overlap with the second set of subframe indices for HARQ-ACK receptions by a second eNB.

In a seventh embodiment, a method of setting up an eNodeB (eNB) in an inter-eNB Carrier Aggregation (CA) system includes transmitting and receiving control information by the eNB, wherein the control information includes a partitioning of subframes so that no two DL assignment or UL grant from two or more eNBs are sent to the UE in the same subframe.

In an eighth embodiment, a system for use in a wireless network includes a first eNodeB (eNB) configured to participate with at least a second eNB in inter-eNB Carrier Aggregation (CA). The first eNB is configured to receive coordination information identifying how SCellIndex values should be assigned to one or more SCells associated with the first eNB or one or more SCells associated with the second eNB. The first eNB includes processing circuitry. The processing circuitry is configured to assign a smallest SCellIndex value to an SCell of the first eNB when the first eNB detects that the second eNB controls a PCell.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The teem “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. It should be noted that the functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Definitions for certain other words and phrases are provided throughout this patent document, and those of ordinary skill in the art should understand that in many if not most instances, such definitions apply to prior as well as future uses of such defined words and phrases. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example embodiment of a wireless communication network according to this disclosure;

FIGS. 2A and 2B illustrate example embodiments of orthogonal frequency division multiple access (OFDMA) transmit and receive paths according to this disclosure;

FIG. 3 illustrates an example embodiment of a user equipment according to this disclosure;

FIGS. 4 through 6 illustrate example embodiments of inter-site carrier aggregation (CA) deployment scenarios according to this disclosure;

FIG. 7 illustrates an example embodiment of a MAC layer, RLC layer and PDCP layer of an eNodeB (eNB) according to this disclosure;

FIGS. 8 and 9 illustrate additional example embodiments of inter-site CA deployment scenarios according to this disclosure;

FIGS. 10 and 11 illustrate example embodiments of Uplink Control Information (UCI) transmissions for eNBs participating in inter-eNB CA according to this disclosure; and

FIG. 12 illustrates an example embodiment of an inter-eNB CA coordination procedure according to this disclosure.

### DETAILED DESCRIPTION

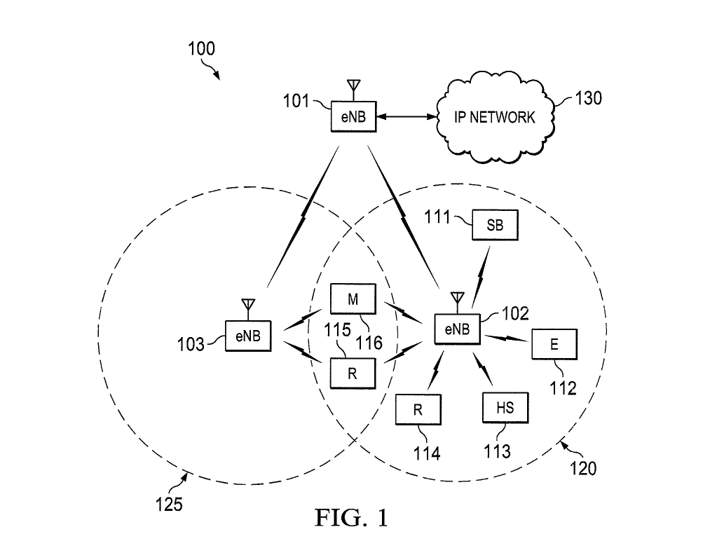

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

The following documents and standards descriptions are hereby incorporated into this disclosure as if fully set forth herein: (i) 3GPP TS 36.211 v10.3.0, “E-UTRA, Physical channels and modulation” (“REF1”); (ii) 3GPP TS 36.212 v10.3.0, “E-UTRA, Multiplexing and Channel coding” (“REF2”); (iii) 3GPP TS 36.213 v11.0.0 (2012-09), “E-UTRA, Physical Layer Procedures” (“REF3”); (iv) 3GPP TS 36.214 v10.1.0, “E-UTRA, Physical Layer Measurement” (“REF4”); (v) 3GPP TS 36.300 V10.7.0 (2012-03) (“REF5”); (vi) 3GPP TS 36.321 V10.5.0 (2012-03) (“REF6”).

FIG. 1 illustrates an example embodiment of a wireless communication network 100 according to this disclosure. As shown in FIG. 1, the wireless network 100 includes an eNodeB (eNB) 101, an eNB 102, and an eNB 103. The eNB 101 communicates with the eNB 102 and the eNB 103. The eNB 101 also communicates with an Internet Protocol (IP) network 130, such as the Internet, a proprietary IP network, or other data network. The eNB 102 and the eNB 103 are able to access the network 130 via the eNB 101 in this example.

The eNB 102 provides wireless broadband access to the network 130 (via the eNB 101) to user equipment (UE) within a coverage area 120 of the eNB 102. The UEs here include UE 111, which may be located in a small business (SB); UE 112, which may be located in an enterprise (E); UE 113, which may be located in a WiFi hotspot (HS); UE 114, which may be located in a first residence (R); UE 115, which may be located in a second residence (R); and UE 116, which may be a mobile device (M) (such as a cell phone, wireless laptop computer, or wireless personal digital assistant). Each of the UEs 111-116 may represent a mobile device or a stationary device. The eNB 103 provides wireless broadband access to the network 130 (via the eNB 101) to UEs within a coverage area 125 of the eNB 103. The UEs here include the UE 115 and the UE 116. In some embodiments, one or more of the eNBs 101-103 may communicate with each other and with the UEs 111-116 using LTE or LTE-A techniques. Additionally, one or more of the eNBs 101-103 can communicate using inter-eNB coordination methods as described herein.

Dotted lines show the approximate extents of the coverage areas 120 and 125, which are shown as approximately circular for illustration and explanation only. The coverage areas 120 and 125 may have other shapes, including irregular shapes, depending upon factors like the configurations of the eNBs and variations in radio environments associated with natural and man-made obstructions.

Depending on the network type, other well-known terms may be used instead of “eNodeB” or “eNB” for each of the components 101-103, such as “base station” or “access point.” For the sake of convenience, the terms “eNodeB” and “eNB” are used here to refer to each of the network infrastructure components that provides wireless access to remote wireless equipment. Also, depending on the network type, other well-known terms may be used instead of “user equipment” or “UE” for each of the components 111-116, such as “mobile station” (MS), “subscriber station” (SS), “remote terminal” (RT), “wireless terminal” (WT), and “user device.”For the sake of convenience, the terms “user equipment” and “UE” are used here to refer to remote wireless equipment that wirelessly accesses an eNB, whether the UE is a mobile device (such as a cell phone) or is normally considered a stationary device (such as a desktop computer or vending machine).

In some embodiments, the eNBs 101-103 may communicate with each other and with the UEs 111-116 using Orthogonal Frequency-Division Multiplexing (OFDM) or Orthogonal Frequency-Division Multiple Access (OFDMA) techniques. Also, each eNB 101-103 can have a globally unique identifier, such as a unique base station identifier (BSID). A BSID is often a media access control (MAC) identifier. Each eNB 101-103 can have multiple cells (such as when one sector represents one cell), and each cell can have a physical cell identifier or a preamble sequence, which is often carried in a synchronization channel.

Although FIG. 1 illustrates one example of a wireless network 100, various changes may be made to FIG. 1. For example, the network 100 could include any number of eNBs and any number of UEs in any suitable arrangement. Also, the eNB 101 could communicate directly with any number of UEs and provide those UEs with wireless broadband access to the network 130. Further, the eNB 101 could provide access to other or additional external networks, such as an external telephone network. In addition, the makeup and arrangement of the wireless network 100 is for illustration only.

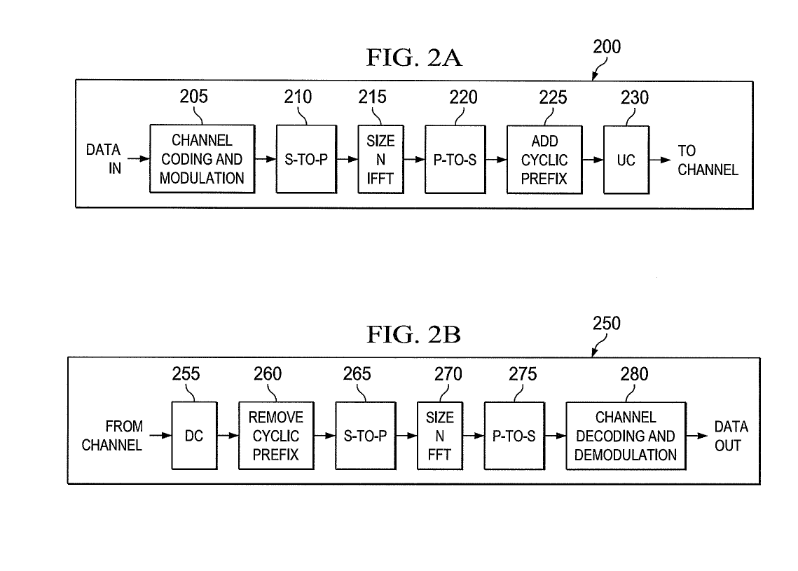

FIGS. 2A and 2B illustrate example embodiments of orthogonal frequency division multiple access (OFDMA) transmit and receive paths according to this disclosure. In FIG. 2A, a transmit path 200 may be implemented in an eNB, such as eNB 102 of FIG. 1. In FIG. 2B, a receive path 250 may be implemented in a UE, such as UE 116 of FIG. 1. It will be understood, however, that the receive path 250 could be implemented in an eNB (such as eNB 102 of FIG. 1) and that the transmit path 200 could be implemented in a UE. The transmit path 200 and the receive path 250 can be configured to implement inter-eNB coordination methods as described herein.

The transmit path 200 includes channel coding and modulation block 205, serial-to-parallel (S-to-P) block 210, size N Inverse Fast Fourier Transform (IFFT) block 215, parallel-to-serial (P-to-S) block 220, add cyclic prefix block 225, and up-converter (UC) 230. The receive path 250 includes down-converter (DC) 255, remove cyclic prefix block 260, serial-to-parallel (S-to-P) block 265, size N Fast Fourier Transform (FFT) block 270, parallel-to-serial (P-to-S) block 275, and channel decoding and demodulation block 280.

In some embodiments, at least some of the components in FIGS. 2A and 2B may be implemented in software, while other components may be implemented by configurable hardware or a mixture of software and configurable hardware. As particular examples, it is noted that the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, could be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

In the transmit path 200, the channel coding and modulation block 205 receives a set of information bits, applies coding (such as Turbo or LDPC coding), and modulates the input bits (such as with Quadrature Phase Shift Keying (QPSK) or Quadrature Amplitude Modulation (QAM)) to produce a sequence of frequency-domain modulation symbols. The serial-to-parallel block 210 converts (such as de-multiplexes) the serial modulated symbols to parallel data to produce N parallel symbol streams, where N is the IFFT/FFT size used in eNB 102 and UE 116. The size N IFFT block 215 performs an IFFT operation on the N parallel symbol streams to produce time-domain output signals. The parallel-to-serial block 220 converts (such as multiplexes) the parallel time-domain output symbols from the size N IFFT block 215 to produce a serial time-domain signal. The add cyclic prefix block 225 inserts a cyclic prefix to the time-domain signal. The up-converter 230 modulates (such as up-converts) the output of the add cyclic prefix block 225 to RF frequency for transmission via a wireless channel. The signal may also be filtered at baseband before conversion to RF frequency.

The transmitted RF signal arrives at the UE 116 after passing through the wireless channel, and reverse operations to those at the eNB 102 are performed. The down-converter 255 down-converts the received signal to baseband frequency, and the remove cyclic prefix block 260 removes the cyclic prefix to produce the serial time-domain baseband signal. The serial-to-parallel block 265 converts the time-domain baseband signal to parallel time domain signals. The size N FFT block 270 performs an FFT algorithm to produce N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the eNBs 101-103 may implement a transmit path that is analogous to transmitting in the downlink to UEs 111-116 and may implement a receive path that is analogous to receiving in the uplink from UEs 111-116. Similarly, each of UEs 111-116 may implement a transmit path corresponding to the architecture for transmitting in the uplink to eNBs 101-103 and may implement a receive path corresponding to the architecture for receiving in the downlink from eNBs 101-103.

In some embodiments, an eNB can have one or multiple cells, and each cell can have one or multiple antenna arrays. Also, each array within a cell can have a different frame structure, such as different uplink and downlink ratios in a time division duplex (TDD) system. Multiple TX/RX (transmitting/receiving) chains can be applied in one array or in one cell. One or multiple antenna arrays in a cell can have the same downlink control channel (such as synchronization channel, physical broadcast channel, and the like) transmission, while other channels (such as data channels) can be transmitted in the frame structure specific to each antenna array.

Although FIGS. 2A and 2B illustrate examples of OFDMA transmit and receive paths, various changes may be made to FIGS. 2A and 2B. For example, various components in FIGS. 2A and 2B could be combined, further subdivided, or omitted and additional components could be added according to particular needs.

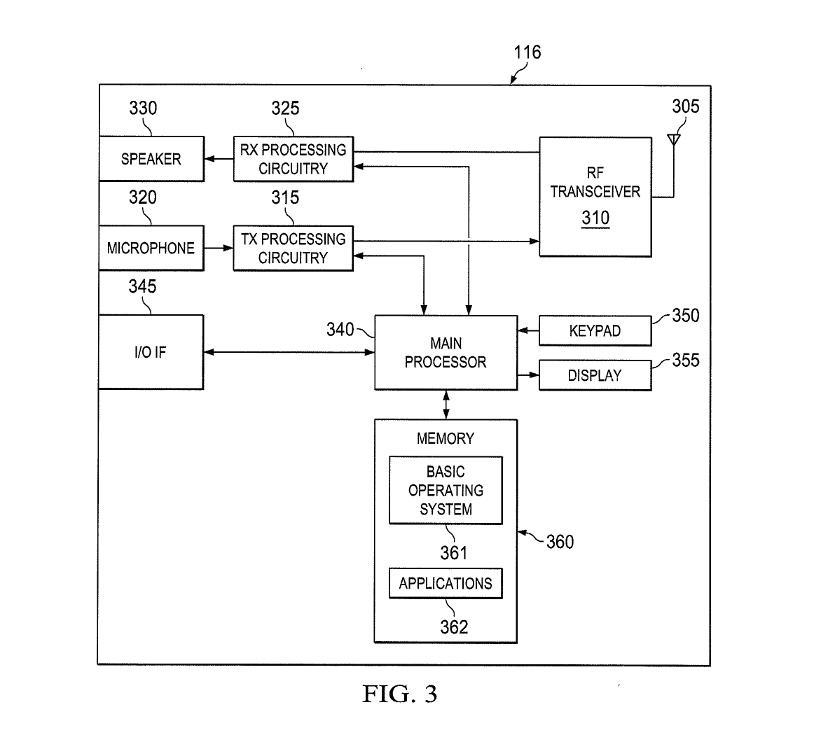

FIG. 3 illustrates an example embodiment of a UE 116 according to this disclosure. The UEs 111-115 of FIG. 1 could have the same or similar configuration. Note, however, that UEs come in a wide variety of configurations and that FIG. 3 does not limit this disclosure to any particular implementation of a UE.

As shown in FIG. 3, the UE 116 includes an antenna 305, radio frequency (RF) transceiver 310, transmit (TX) processing circuitry 315, microphone 320, and receive (RX) processing circuitry 325. The UE 116 also includes a speaker 330, main processor 340, input/output (I/O) interface (IF) 345, keypad 350, display 355, and memory 360. The memory 360 includes a basic operating system (OS) program 361 and a plurality of applications 362.

The RF transceiver 310 receives, from the antenna 305, an incoming RF signal transmitted by an eNB of the network 100. The RF transceiver 310 down-converts the incoming RF signal to produce an intermediate frequency (IF) or a baseband signal. The IF or baseband signal is sent to the RX processing circuitry 325, which produces a processed baseband signal by filtering, decoding, and/or digitizing the baseband or IF signal. The RX processing circuitry 325 transmits the processed baseband signal to the speaker 330 (such as voice data) or to the main processor 340 for further processing (such as web browsing).

The TX processing circuitry 315 receives analog or digital voice data from the microphone 320 or other outgoing baseband data (such as web data, e-mail, interactive video game data) from the main processor 340. The TX processing circuitry 315 encodes, multiplexes, and/or digitizes the outgoing baseband data to produce a processed baseband or IF signal. The RF transceiver 310 receives the outgoing processed baseband or IF signal from the TX processing circuitry 315 and up-converts the baseband or IF signal to an RF signal that is transmitted via the antenna 305.

In some embodiments, the main processor 340 is a microprocessor or microcontroller. The memory 360 is coupled to the main processor 340. Part of the memory 360 could include a random access memory (RAM), and another part of the memory 360 could include a Flash memory or other read-only memory (ROM).

The main processor 340 can include one or more processors and execute the basic OS program 361 stored in the memory 360 in order to control the overall operation of the UE 116. In one such operation, the main processor 340 controls the reception of forward channel signals and the transmission of reverse channel signals by the RF transceiver 310, the RX processing circuitry 325, and the TX processing circuitry 315 in accordance with well-known principles. The main processor 340 can also include processing circuitry configured to allocate one or more resources. For example, the main processor 340 can include allocator processing circuitry configured to allocate a unique carrier indicator and detector processing circuitry configured to detect a physical downlink control channel (PDCCH) scheduling a physical downlink shared channel (PDSCH) reception of a physical uplink shared channel (PUSCH) transmission in one of the carriers. Downlink Control Information (DCI) serves several purposes and is conveyed through DCI formats in respective PDCCHs. For example, a DCI format may correspond to a downlink Scheduling Assignment (SA) for PDSCH receptions or to an uplink SA for PUSCH transmissions.

The main processor 340 is also capable of executing other processes and programs resident in the memory 360, such as operations for inter-eNB coordination methods to support inter-eNB carrier aggregation. It should be understood that inter-eNB carrier aggregation can also be referred to as dual connectivity. The main processor 340 can move data into or out of the memory 360 as required by an executing process. In some embodiments, the main processor 340 is configured to execute a plurality of applications 362, such as applications for MU-MIMO communications, including obtaining control channel elements of PDCCHs. The main processor 340 can operate the plurality of applications 362 based on the OS program 361 or in response to a signal received from an eNB. The main processor 340 is also coupled to the I/O interface 345, which provides UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites.

Although FIG. 3 illustrates one example of UE 116, various changes may be made to FIG. 3. For example, various components in FIG. 3 could be combined, further subdivided, or omitted and additional components could be added according to particular needs. Also, while FIG. 3 illustrates the UE 116 operating as a mobile telephone, UEs could be configured to operate as other types of mobile or stationary devices.

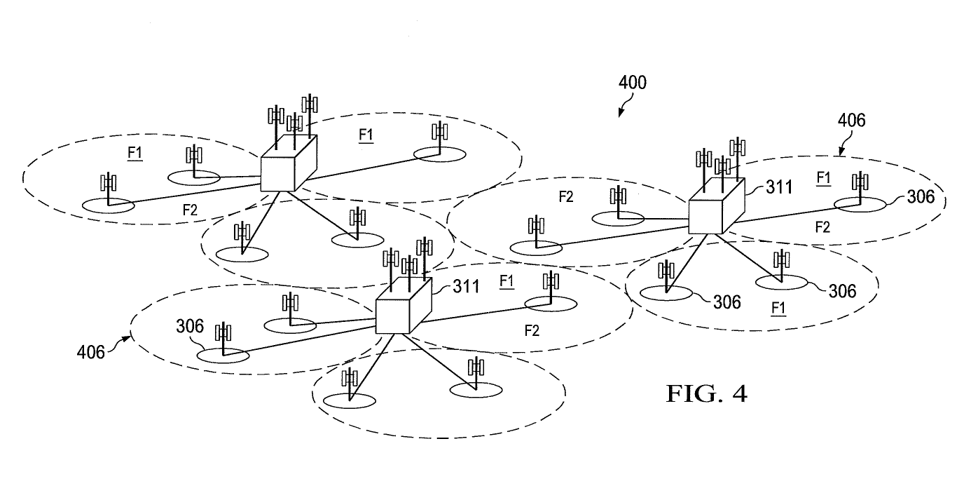

FIGS. 4 through 6 illustrate example embodiments of inter-site carrier aggregation (CA) deployment scenarios according to this disclosure. Carrier aggregation refers to the ability to combine multiple channels into a wider spectrum, which allows communications to occur at improved bandwidths.

In Rel-10 LTE, carrier aggregation was introduced to increase peak throughput of UEs. For example, in one CA scenario as illustrated in FIG. 4, a number of pico sites 402 are deployed within the coverage area 406 of a macro site 404. The macro site 404 transmits and receives signals using a carrier frequency F1, and pico sites 402 transmit and receive signals using a carrier frequency F2. In Rel-10, it was assumed that there are fast fiber connections between the macro and pico sites so that data can be sent with very small latency. Furthermore, in Rel-10, uplink control information (UCI)—such as uplink (UL) hybrid automatic repeat request and acknowledgment (HARQ-ACK) and channel state information (CSI) feedback for a cell—can be transmitted on the UL carrier of a different cell. For example, as shown in FIG. 5, if a UE 510 is transmitting PUSCH on a PCell, the UL HARQ-ACK and CSI of all aggregated cells are transmitted on the PCell. Additionally, in Rel-10, the UE 510 transmits PUCCH, which can be used to carry UCI only on the PCell. Under certain conditions, the UCI of all cells may also be transmitted on an SCell via PUSCH on the SCell.

In Release 11 (Rel-11) of the LTE wireless standard, to better support UL CA for inter-site CA, 3GPP standardized the features of multiple timing advances and random access procedures for the SCell. For example, as illustrated in FIG. 6, Rel-11 allowed for Msg 2 of the RA procedure on the SCell to be transmitted on the common search space of the PCell. Here, “PCell” and “SCell” refer to different serving cells (typically one for each component carrier being combined).

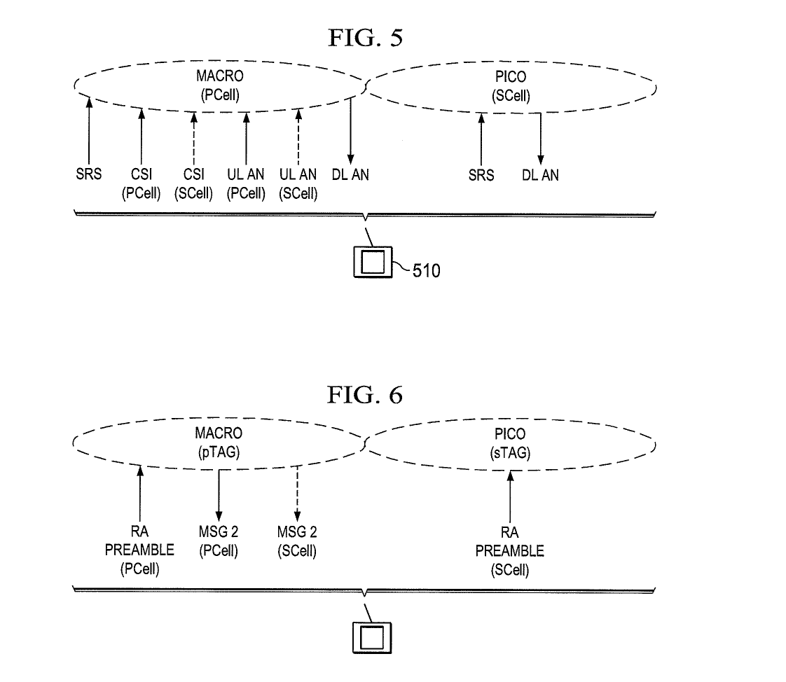

Inter-site CA in Rel-10 requires very tight coordination of cells, which can be achieved by having fast fiber connections between sites and by having a central controller (such as an eNB) controlling the cells. Additionally, a scheduler for the multiple cells is typically centralized. FIG. 7 illustrates an example embodiment of a physical layer of an eNB according to this disclosure. In Rel-10, as illustrated in FIG. 7, the multi-carrier nature of the physical layer is only exposed to the MAC layer for which one HARQ entity is required per serving cell. As the number of cells controlled by the eNB increases, the cost of backhaul transport also increases as more fibers need to be used.

The cost of backhaul can be reduced if the backhaul is copper-based or microwave-based. However, with copper-based or microwave-based backhaul, often the stringent coordination requirements between sites in order to implement these types of backhauls may not be met. To cure this deficiency, an inter-eNB CA architecture can be implemented using distributed controllers such that each site can have a specified level of autonomous scheduling operation.

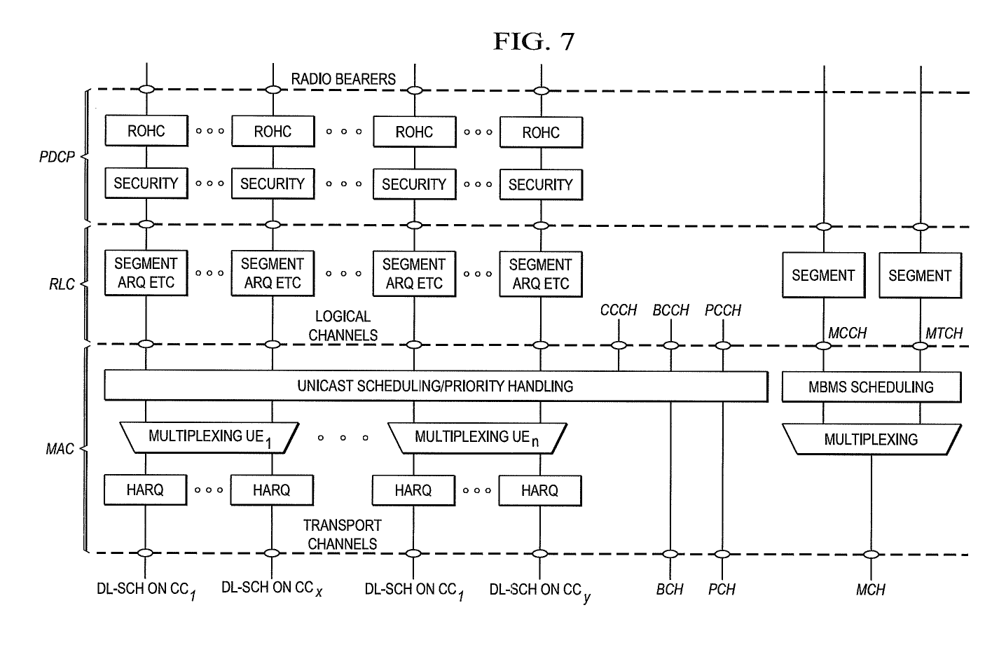

FIGS. 8 and 9 illustrate additional example embodiments of inter-site CA deployment scenarios according to this disclosure. With an inter-eNB CA architecture as illustrated in FIG. 8, the UCI data needed for a cell scheduler does not need to be transmitted to another cell of a different site. In other words, as illustrated in FIG. 9, the UCI data of a cell of a particular site can be transmitted to a cell of the same site. Additionally, with this inter-eNB CA architecture, Msg 2 can be transmitted on a cell of the same site where the RA preamble was transmitted. It should be noted that the eNB controlling the PCell may be referred to as a “serving” eNB, while the eNB controlling the SCell at a different site may be referred to as a “drift” eNB.

Under Rel-10/11, a UE procedure for determining physical uplink control channel assignments based on predefined rules can be used in order for a UE to determine how uplink control information should be transmitted. For example, a UE can determine if it is configured for transmission with a single serving cell or if it is configured for simultaneous PUSCH and PUCCH transmissions. If the UE determines that it is configured for a single serving cell and not configured for simultaneous PUSCH and PUCCH transmissions, the UE can determine if the UE is transmitting on PUCCH or PUSCH. If the UE is not transmitting on PUSCH, the UE can transmit uplink control information (UCI) in subframe “n” on PUCCH using format 1/1a/1b/3 or 2/2a/2b.

If the UE is not transmitting on the PUCCH, the UE can determine if it is transmitting on the PUSCH in subframe “n”. If the UE determines that it is not transmitting on the PUSCH in subframe “n”, the procedure can end. Conversely, if the UE determines that the UE is transmitting on the PUSCH in subframe “n”, the UE can determine if the PUSCH transmission corresponds to a Random Access Response Grant or a retransmission of the same transport block as part of a contention based random access procedure.

If the UE determines that the PUSCH transmission corresponds to a Random Access Response Grant or a retransmission of the same transport block as part of the contention based random access procedure, the UE does not transmit the UCI. However, if the UE determines that the PUSCH transmission does not correspond to a Random Access Response Grant or a retransmission of the same transport block as part of the contention based random access procedure, the UE can transmit the UCI on the PUSCH in subframe “n”.

In another example, a UE can determine if it is configured for transmission with a single serving cell and for simultaneous PUSCH and PUCCH transmissions. If the UE determines that it is configured for a single serving cell and for simultaneous PUSCH and PUCCH transmissions, the UE can determine if the UCI consists only of HARQ-ACKs and/or scheduling requests (SRs), if the UCI consists only of periodic CSIs, if the UE is not transmitting on the PUSCH, or if the UCI consists of HARQ-ACKs/HARQ-ACK+SR/positive SRs and periodic/aperiodic CSIs.

If the UE determines that the UCI consist only of HARQ-ACKs and/or SRs, the UE transmits the UCI on the PUCCH using format 1/1a/1b/3 in subframe “n”. If the UE determines that the UCI consists only of periodic CSI, the UE transmits the UCI on the PUCCH using format 2 in subframe “n”.

Furthermore, if the UE is not transmitting on the PUSCH, the UE can determine if the UCI consists of periodic CSI and HARQ-ACK. If the UE determines that the UCI does consist of periodic CSI and HARQ-ACK, the UE transmits the UCI on the PUCCH using format 2/2a/2b in subframe “n”. If the UE determines that the UCI consists of HARQ-ACK/HARQ-ACK+SR/positive SR and periodic/aperiodic CSI, the UE can determine if the PUSCH transmission corresponds to a Random Access Response Grant or a retransmission of the same transport block as part of the contention based random access procedure.

If the PUSCH transmission corresponds to a Random Access Response Grant or a retransmission of the same transport block as part of the contention based random access procedure, the periodic/aperiodic CSI is not transmitted. If the PUSCH transmission does not correspond to a Random Access Response Grant or a retransmission of the same transport block as part of the contention based random access procedure, the UCI is transmitted on the PUCCH and the PUSCH such that the HARQ-ACK/HARQ-ACK+SR/positive SR is transmitted on the PUCCH using format 1/1 a/1b/3 and the periodic/aperiodic CSI is transmitted on the PUSCH.

In yet another example, a UE can determine if it is configured with more than one serving cell and is not configured for simultaneous PUSCH and PUCCH transmissions. If the UE determines that the UE is configured with more than one serving cell and is not configured for simultaneous PUSCH and PUCCH transmissions, the UE can determine if the UE is not transmitting on the PUSCH, if the UCI consists of aperiodic CSI or aperiodic CSI and HARQ-ACK, if the UE is transmitting on the primary cell PUSCH in subframe “n”, and if the UE is not transmitting on the PUSCH of primary cell but is transmitting on the PUSCH of at least one secondary cell. If the UE is not transmitting on PUSCH, the UE can transmit the UCI in subframe “n” on the PUCCH using format 1/1a/1b/3 or 2/2a/2b. If the UCI consists of aperiodic CSI or aperiodic CSI and HARQ-ACK, the UE can transmit the UCI in subframe “n” on the PUSCH of the serving cell.

Conversely, if the UE is transmitting on the primary cell PUSCH in subframe “n”, the UE can determine if the UCI consists of periodic CSI and/or HARQ-ACK and if the primary cell PUSCH transmission corresponds to a Random Access Response Grant or a retransmission of the same transport block as part of the contention based random access procedure. If the UE determines that the UCI does consist of periodic CSI and/or HARQ-ACK and the primary cell PUSCH transmission does not corresponds to a Random Access Response Grant or a retransmission of the same transport block as part of the contention based random access procedure, the UE can determine that the UCI is transmitted on the primary cell PUSCH. If the primary cell PUSCH transmission corresponds to a Random Access Response Grant or a retransmission of the same transport block as part of the contention based random access procedure, the UCI is not transmitted.

Additionally, if the UE is not transmitting on the PUSCH of the primary cell but is transmitting on the PUSCH of at least one secondary cell, the UE can determine if the UCI consists of periodic CSI and/or HARQ-ACK. In this case, if the UE determines that the UCI consists of periodic CSI and/or HARQ-ACK, the UE can transmit the UCI in subframe “n” on the PUSCH of a second cell with the smallest SCellIndex.

In another example, a UE can determine if it is configured with more than one serving cell and simultaneous PUSCH and PUCCH transmissions. If the UE determines that it is configured with more than one serving cell and simultaneous PUSCH and PUCCH transmissions, the UE can determine if the UCI consists only of HARQ-ACK and/or SR, if the UCI consists only of periodic CSI, if the UCI consists of periodic CSI and HARQ-ACK and the UE is not transmitting on PUSCH, if the UCI consists of HARQ-ACK and periodic CSI and the UE is transmitting PUSCH on the primary cell, or if the UCI consists of HARQ-ACK/HARQ-ACK+SR/positive SR and aperiodic CSI.

If the UE determines that the UCI consists only of HARQ-ACK and/or SR, the UCI is transmitted in subframe “n” on the PUCCH using format 1/1a/1b/3. If the UE determines that the UCI consists only of periodic CSI, the UE can detemrine if the UCI is transmitted in subframe “n” on the PUCCH using format 2. If the UE can determine that the UCI consists of HARQ-ACK and periodic CSI and the UE is transmitting on the PUSCH of the primary cell, the UE can determine if the primary cell PUSCH transmission corresponds to a Random Access Response Grant or a retransmission of the same transport block as part of the contention based random access procedure. In this case, if the UE determines that the primary cell PUSCH transmission does not correspond to a Random Access Response Grant or a retransmission of the same transport block as part of the contention based random access procedure, the UCI is transmitted in the subframe “n” on the PUCCH and primary cell PUSCH such that the HARQ-ACK is transmitted on PUCCH using format 1a/1b/3 and the periodic CSI is transmitted on the PUSCH. If the UE determines that the primary cell PUSCH transmission corresponds to a Random Access Response Grant or a retransmission of the same transport block as part of the contention based random access procedure, the periodic CSI is not transmitted.

Additionally, if the UE determines that the UCI consists of HARQ-ACK and periodic CSI and if the UE is not transmitting on the PUSCH of a primary cell but is transmitting on the PUSCH of at least one secondary cell, the UE determines that the UCI is transmitted in the subframe “n” on the PUCCH and the PUSCH of the secondary cell with the smallest SCellIndex such that HARQ-ACK is transmitted on the PUCCH using format 1a/1b/3 and the periodic CSI is transmitted on the PUSCH. If the UE determines that the UCI consists of HARQ-ACK/HARQ-ACK+SR/positive SR and aperiodic CSI, the UCI is transmitted in the subframe “n” on the PUCCH and the PUSCH such that the HARQ-ACK/HARQ-ACK+SR/positive SR is transmitted on the PUCCH using format 1/1a/1b/3 and the aperiodic CSI is transmitted on the PUSCH of the serving cell.

In another example, if the UE determines that it is configured with more than one serving cell, reporting prioritization and collision handling of periodic CSI reports of a certain PUCCH reporting type is given in Sec 7.2.2 of 3GPP TS 36.213 when simultaneous transmission of periodic CSI reports of multiple serving cell is not supported. In some embodiments, a UE transmits PUCCH only on the primary cell.

In accordance with this disclosure, various methods are provided to enable the support of inter-eNB carrier aggregation at the physical layer. As discussed here, Rel-10/11 provides a set of rules defined for the UE to determine how UCI data should be transmitted. Assuming that each eNB participating in inter-eNB CA can only receive uplink signals on its own UL carrier frequency, the methods described here ensure that UCIs for the eNBs participating in inter-eNB CA can be received by the eNBs on their own UL carrier frequencies.

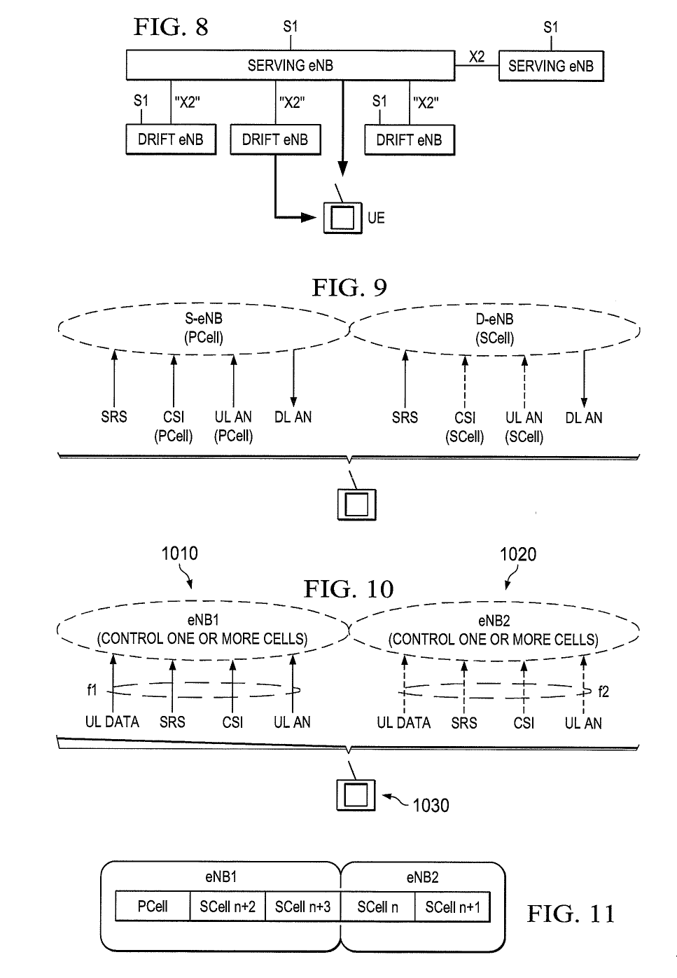

FIGS. 10 and 11 illustrate example embodiments of UCI transmissions for eNBs participating in inter-eNB CA according to this disclosure. As shown in FIG. 10, eNBs 1010-1020 can correspond to different sets of serving cells. In order to ensure that the UCIs for eNBs participating in inter-eNB CA can be received by the eNBs on their own UL carrier frequencies (f1 for eNB 1010 and f2 for eNB 1020), coordinating procedures can be implemented.

The coordinating procedures can be implemented based on the configuration of a UE 1030. For example, the UE 1030 can be configured for simultaneous PUCCH and PUSCH transmissions. In Rel-10/11, if the UE 1030 is configured with more than one serving cell, HARQ-ACKs for serving cells are always transmitted on the PUCCH on the PCell. In other words, HARQ-ACKs for every eNB participating in inter-eNB CA are transmitted to only the eNB controlling the PCell. In order to avoid this scenario, a coordinating procedure between the eNBs participating in inter-eNB CA can include one of the eNBs not configuring the UE 1030 with simultaneous PUSCH and PUCCH transmissions for inter-eNB CA, or not allowing the UE 1030 to participate in inter-eNB CA when the UE 1030 is configured for simultaneous PUSCH and PUCCH transmissions. Consequently, the UE 1030 when configured with inter-eNB CA should not be configured for simultaneous PUSCH and PUCCH transmissions.

The coordinating procedures can also be implemented for channel state information (CSI) feedback transmissions. Table 1 illustrates an example embodiment of CSI request fields for physical downlink control channel/enhanced physical downlink control channel (PDCCH/EPDCCH) with an uplink DCI format in the UE specific search space according to this disclosure. As illustrated in Table 1, for Rel-10/11 CA, the value of the aperiodic CSI request field in the DCI formats for the UL grant (such as DCI format 0/4) determines the set of cells of which the corresponding aperiodic CSI feedback should be transmitted by the UE 1030.

TABLE 1

| Value of CSI request field | Description |
|---|---|
| ‘00’ | No aperiodic CSI report is triggered |
| ‘01’ | Aperiodic CSI report is triggered for |
| | serving cell^{c} |
| ‘10’ | Aperiodic CSI report is triggered for a 1st |
| | set of serving cells configured by higher |
| | layers |
| ‘11’ | Aperiodic CSI report is triggered for a 2nd |
| | set of serving cells configured by higher |
| | layers |

If the aperiodic CSI for more than one cell is triggered by a UL grant scheduling a PUSCH on a UL carrier, all the CSIs are multiplexed on the PUSCH. In order to allow individual eNBs (such as eNB 1010 and eNB 1020) participating in inter-eNB CA to request aperiodic CSI reports and receive a report on the UL carrier associated with an eNB, the eNBs participating in inter-eNB CA can implement one or more of the following coordinating procedures.

In some embodiments, as disclosed in Rel-10/11, if the UE 1030 is not expected to receive more than one aperiodic CSI report request for a given subframe, a coordinating procedure can include partitioning the DL subframes so that no two aperiodic CSI report requests from two eNBs (such as eNB 1010 and eNB 1020) can be sent to the UE 1030 in the same subframe. For example, coordinating procedures transmitted using X2 messaging or transmitted by a central entity can be done such that the eNBs participating in inter-eNB CA understand that a particular eNB participating in inter-eNB does not send its own aperiodic CSI report requests on one or more predetermined DL subframes while the same particular eNB is allowed to send its own aperiodic CSI report request on one or more different predetermined DL subframes. Table 2 illustrates an example embodiment of DL subframe partitioning among eNBs participating in inter-eNB CA for aperiodic CSI report requests according to this disclosure.

TABLE 2

| | | UL subframe index for |
|---|---|---|
| | DL subframes index for which aperiodic | which the aperiodic |
| eNB | CSI request can be sent | CSI is sent |
| eNB 1 | 0, 2, 4, 6, 8 | 4, 6, 8, 0, 2 |
| eNB 2 | 1, 3, 5, 7, 9 | 5, 7, 9, 1, 3 |

As shown in Table 2, the number of DL subframes assigned for each eNB can depend on how an eNB's carrier may be utilized for DL data transmission. For instance, if the DL carrier of eNB 1020 is utilized most of the time due to its better path loss to the UE 1030, more DL subframes can be assigned for the eNB 1020. For another instance, if the DL carrier of eNB 1020 is utilized most of the time due to the heavier data traffic to the UE 1030 or due to the QoS requirement of the bearer type set up between the eNB 1020 and the UE 1030, more DL subframes can be assigned for the eNB 1020.

Table 3 illustrates another example embodiment of DL subframe partitioning among eNBs participating in inter-eNB CA for aperiodic CSI report requests according to this disclosure.

TABLE 3

| | | UL subframe index for |
|---|---|---|
| | DL subframes index for which aperiodic | which the aperiodic |
| eNB | CSI request can be sent | CSI is sent |
| eNB 1 | 0, 5 | 4, 9 |
| eNB 2 | 1, 2, 3, 4, 6, 7, 8, 9 | 3, 5, 6, 7, 8, 0, 1, 2 |

In some embodiments, for inter-eNB CA coordinating procedures, subframe partitioning can be defined such that signaling values can be mapped to particular partitioning configurations. Table 4 illustrates an example embodiment of mapping signal values to particular partitioning configurations for an inter-eNB CA coordinating procedure according to this disclosure. For example, as illustrated in Table 4, by assuming that one bit signaling and Tables 2 and 3 are predefined in the coordinating procedure specifications, bit “0” can be mapped to Table 2 and bit “1” can be mapped to Table 3.

TABLE 4

| Signaling value | Partitioning configuration |
|---|---|
| 0 | Table 2 |
| 1 | Table 3 |

In some embodiments, for inter-eNB CA coordinating procedures with certain deployment scenarios, each eNB participating in the inter-eNB CA (such as eNB 1010 and eNB 1020) can have several carriers of its own that can be aggregated. For example, with CA, values ‘10’ and ‘11’ of the aperiodic CSI request field can trigger the aperiodic CSI request reports for a first set of serving cells and for a second set of serving cells, respectively. In this embodiment, the triggers ‘10’ and ‘11’ can be associated with different eNBs. For example, trigger ‘10’ can correspond to a set of serving cells associated with eNB 1010 while trigger ‘11’ can correspond to a set of serving cells associated with eNB 1020. It should be understood that a central entity may be used to coordinate between the eNBs in order to establish which of the aperiodic CSI report request trigger values is assigned to eNB 1010 and which of the aperiodic CSI report request trigger values is assigned to eNB 1020. Table 5 illustrates an example embodiment of aperiodic CSI report request trigger values assigned to eNBs (such as eNB 1010 and eNB 1020) participating in inter-eNB CA according to this disclosure.

TABLE 5

| | Value of aperiodic CSI request that can be |
|---|---|
| eNB | set by the eNB |
| eNB 1 | ‘00’, ‘01’, ‘10’ |
| eNB 2 | ‘00’, ‘01’, ‘11’ |

In some embodiments, for inter-eNB CA coordinating procedures with certain deployment scenarios, a particular eNB participating in inter-eNB CA (such as eNB 1010) can have multiple carriers that can be aggregated for a UE, while another eNB also participating in inter-eNB CA (such as eNB 1020) can have only one carrier that can be configured for a UE. In this embodiment, the eNB with multiple carriers can be permitted to use the trigger values corresponding to multiple cells such as trigger value ‘10’ and trigger value ‘11’. Table 6 illustrates an example embodiment of aperiodic CSI report request trigger values assigned to eNBs (such as eNB 1010 and eNB 1020) participating in inter-eNB CA according to this disclosure.

TABLE 6

| | Value of aperiodic CSI request that can be |
|---|---|
| eNB | set by the eNB |
| eNB 1 | ‘00’, ‘01’, ‘10’, ‘11’ |
| eNB 2 | ‘00’, ‘01’ |

For some inter-eNB CA coordinating procedures, it can be assumed that there is only one Radio Resource Control (RRC) context at the UE 1030, and the eNB 1010 is responsible for the RRC configuration of the UE 1030. In some embodiments, the eNB 1020 can inform the eNB 1010 via X2 messaging on the UE 1030 RRC context of the one or more sets of serving cells that correspond to one or more of eNB 1020's aperiodic CSI trigger codepoints. Once the eNB 1020 informs the eNB 1010 on the UE's 1030 RRC context, the eNB 1010 can perform an RRC configuration to the UE 1030 of the one or more sets of serving cells corresponding to the one or more aperiodic CSI trigger codepoints. For example, assuming eNB 1020 is assigned codepoint ‘11’, eNB 1020 can send an X2 message to eNB 1010 to inform eNB 1010 about the set of serving cells that corresponds to codepoint ‘11’.

In some embodiments, inter-eNB CA coordinating procedures can be implemented for HARQ-ACK transmissions. In Rel-10/11, HARQ-ACKs of multiple cells are transmitted on the same UL carrier (either on the PUCCH or the PUSCH) according to a predetermined timing after the DL assignment is received by the UE 1030. In addition, to enable the HARQ-ACK intended for an eNB to be received by the eNB on its own UL carrier, coordination among eNBs participating in inter-eNB CA can be conducted on the timing of the DL assignment and the UL grant. Coordination on the UL grant timing is also used since according to Rel-10 HARQ-ACK is transmitted on the PUCCH of the PCell, unless at least one PUSCH is scheduled on the one or more serving cells in which case HARQ-ACKs are piggybacked on the PUSCH with the smallest serving cell index selected among the scheduled PUSCHs (assuming simultaneous PUCCH and PUSCH transmissions are not configured for the UE 1030). It should be noted that the eNB that does not control the PCell may always use the PUSCH to carry its HARQ-ACK and thus may never use the PUCCH to carry its HARQ-ACK.

Inter-eNB CA coordinating procedures can ensure that a UE 1030 is not scheduled to transmit HARQ-ACKs intended for different eNBs within the same subframe. In some embodiments, ensuring that a UE 1030 is not scheduled to transmit HARQ-ACKs intended for different eNBs within the same subframe can be used to coordinate the indices for eNB 1010 and eNB 1020 such that the set of subframe indices for HARQ-ACK receptions for eNB 1010 does not overlap with the set of subframe indices for HARQ-ACK receptions for eNB 1020.

In some embodiments, ensuring that a UE 1030 is not scheduled to transmit HARQ-ACKs intended for different eNBs within the same subframe can also be used to coordinate not only the subframes for HARQ-ACK reception but also the subframes for the PUSCH receptions. For example, with Frequency Division Duplexing (FDD), inter-eNB CA coordination procedures can be performed such that two eNBs do not schedule a DL assignment or a UL grant in the same DL subframe. Assuming the Rel-10/11 UE procedure for determining a particular cell of one or more configured serving cells for HARQ-ACK transmission, simultaneous PUCCH and PUSCH transmissions are not configured for the UE 1030.

In some embodiments, under certain deployment scenarios where the PCell is associated with a macro eNB while a pico eNB is handling only one or more SCells, a majority of the DL assignments or UL grants can occur via the one or more SCells in order to conserve energy. Because the path loss between pico eNBs and the UE is typically smaller compared to the path loss between a macro eNB and the UE, DL assignments and UL grants transmitted through one or more SCells can reduce energy consumption. Thus, in these embodiments, a larger number of DL/UL subframes could be assigned to pico eNBs rather than to macro eNBs in order to reduce energy consumption.

As previously disclosed, X2 messaging can be used to transmit coordination procedures to eNBs participating in inter-eNB CA in order to partition subframe indices for the DL assignments and the UL grants. Tables 7 and 8 illustrate example embodiments of subframe partitioning for DL assignments and UL grants for macro eNBs (such as eNB 1010) and for pico eNBs (such as eNB 1020) according to this disclosure. It should be noted that it is possible to jointly perform inter-eNB CA coordination based on the CSI feedback transmissions as well as inter-eNB CA coordination based on HARQ-ACK transmissions because the subframe indices for the UL grants can also be the same subframe indices where aperiodic CSI reporting requests can be sent.

TABLE 7

| | Subframe | Subframe | Subframe | Subframe |
|---|---|---|---|---|
| | indices for DL | indices for | indices for UL | indices for |
| eNB | assignment | HARQ-ACK | grant | PUSCH |
| eNB 1 | 0, 4, 5, 9 | 3, 4, 8, 9 | 0, 4, 5, 9 | 3, 4, 8, 9 |
| (macro) | | | | |
| eNB 2 (pico) | 1, 2, 3, 6, 7, 8 | 5, 6, 7, 0, | 1, 2, 3, 6, 7, 8 | 5, 6, 7, 0, |
| | | 1, 2 | | 1, 2 |

TABLE 8

| | Subframe | Subframe | Subframe | Subframe |
|---|---|---|---|---|
| | indices for DL | indices for | indices for UL | indices for |
| eNB | assignment | HARQ-ACK | grant | PUSCH |
| eNB 1 | 0, 5 | 4, 9 | 0, 5 | 4, 9 |
| (macro) | | | | |
| eNB 2 | 1, 2, 3, 4, 6, | 3, 5, 6, 7, 8, | 1, 2, 3, 4, 6, | 3, 5, 6, 7, 8, |
| (pico) | 7, 8, 9 | 0, 1, 2 | 7, 8, 9 | 0, 1, 2 |

In some embodiments, inter-eNB CA coordinating procedures can be implemented for SCellIndex [3GPP TS 36.331] value assignments. In Rel-10/11 CA, the UCI is transmitted on the PUSCH of an SCell with the smallest SCellIndex value if the condition for transmission on the PCell is not fulfilled. To support transmission of the UCI to the eNB that is not controlling the PCell, the smallest SCellIndex value can be assigned to an SCell (such as of a plurality of SCells) of an eNB that does not control the PCell. For example, if the eNB 1010 controls a PCell and SCell A and the eNB 1020 controls SCell B, SCell B should be assigned the smallest SCellIndex value compared to SCell A and SCell B. Before implementing inter-eNB CA, eNB 1010 can inform eNB 1020 of the smallest SCellIndex value it intends to use or the set of SCellIndex values it intends to use in order to allow eNB 1020 to assign a smaller SCellIndex value to SCell B than the smallest SCellIndex value used by eNB 1010. FIG. 11 illustrates an example embodiment where SCell n means that the SCell is assigned with a SCellIndex equal to “n”, where “n” is an integer greater than 0.

In some embodiments, when at least two eNBs (such as eNB 1010 and eNB 1020) are participating in inter-eNB CA, the SCellIndex values can be coordinated by requiring the eNB that controls the PCell and one or more SCells (such as eNB 1010) to assign SCellIndex value(s) for its own SCell(s) so that each and every SCellIndex value is larger than any SCellIndex values assigned for the serving cells of one or more other eNBs (such as eNB 1020). Thus, the eNB controlling the PCell (such as eNB 1010) can schedule UL data transmissions for its own SCell and only for its own SCell without requiring the UCI in a UL subframe, regardless of the scheduling decision of any other eNBs (such as eNB 1020). In at least these embodiments, the UL scheduling on the PCell can be coordinated to avoid the transmission of the UCI for eNB 1020 on the PCell. With this coordination procedure, eNB 1020 can be required to inform eNB 1010 of the largest SCellIndex value it uses or the set of SCellIndex values it uses so that eNB 1010 can assign SCellIndex values for its own SCell(s) that are larger than any SCellIndex value assigned by eNB 1020.

Furthermore, as illustrated in Table 9, with inter-eNB SCellIndex value coordination, the subframe partitioning with respect to the CSI feedback transmissions and HARQ-ACK transmissions can also be restricted to PCells or SCells with the UCI for eNB 1010. Table 9 illustrates an example embodiment of subframe partitioning for DL assignments and UL grants for macro eNBs (such as eNB 1010) and for pico eNBs (such as eNB 1020) with SCellIndex value coordination according to this disclosure.

TABLE 9

| | | Subframe | Subframe | Subframe |
|---|---|---|---|---|
| | Subframe indices | indices for | indices for UL | indices for |
| eNB | for DL assignment | HARQ-ACK | grant | PUSCH |
| eNB 1 (macro) | 0, 4, 5, 9 | 3, 4, 8, 9 | 0, 4, 5, 9 (PCell | 3, 4, 8, 9 (PCell |
| Min SCellIndex > | | | or SCell with | or SCell with |
| max SCellIndex used | | | UCI); | UCI); |
| by eNB 1020 | | | All for SCell | All for SCell |
| | | | without UCI | without UCI |
| eNB 2 (pico) | 1, 2, 3, 6, 7, 8 | 5, 6, 7, 0, 1, 2 | 1, 2, 3, 6, 7, 8 | 5, 6, 7, 0, 1, 2 |

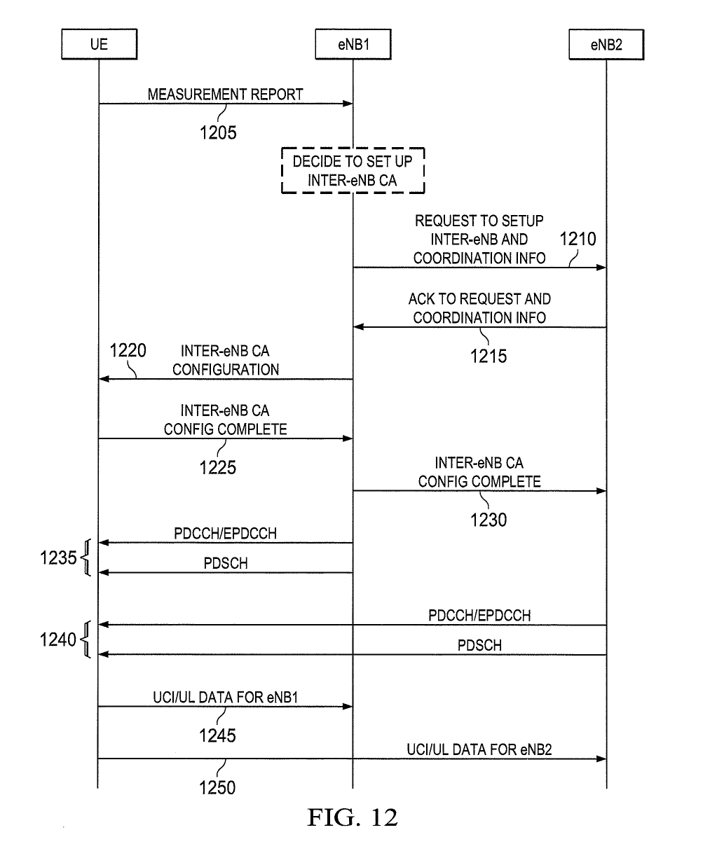

FIG. 12 illustrates an example embodiment of an inter-eNB CA coordination procedure 1200 according to this disclosure. It should be understood that the coordination procedure disclosed here can be applied to any of the embodiments disclosed above.

At operation 1205, a UE transmits a measurement report to eNB 1010. At this point, eNB 1010 can determine whether to set up inter-eNB CA. At operation 1210, eNB 1010 transmits a request to set up inter-eNB CA and coordination information (such as coordination procedures) with eNB 1020. At operation 1215, eNB 1020 transmits HARQ-ACK and coordination information to eNB 1010. At operation 1220, eNB 1010 transmits inter-eNB CA configuration information to the UE in order to configure the UE for inter-eNB CA. At operation 1225, the UE transmits a signal to eNB 1010 indicating that the UE is configured for inter-eNB CA. At operation 1230, eNB 1010 transmits the signal from the UE to eNB 1020 indicating that the UE is configured for inter-eNB CA. At operation 1235, eNB 1010 transmits data via the PDCCH/EPDCCH and the PDSCH based on the DL assignments provided for eNB 1010. At operation 1240, eNB 1020 transmits data via the PDCCH/EPDCCH and the PDSCH based on the DL assignments provided for eNB 1020. At operation 1245, the UE transmits the UCI or the UL data to eNB 1010. At operation 1250, the UE transmits the UCI or the UL data to eNB 1020.

One advantage of the various embodiments of this disclosure is that it is possible to support inter-eNB CA for legacy UEs (such as Rel-10/11 UEs). It may also be beneficial to signal coordination information to the UE, such as with the subframe partitioning illustrated in Tables 2 through 8, so that the UE is able to recognize error events (such as receiving a DL assignment from an eNB that the UE is supposed to avoid). By identifying the error events, the UE is able to discard erroneous commands from an eNB or false alarms so that the normal operation of inter-eNB CA is not negatively impacted.

Coordination between eNBs as described in this disclosure can occur at a time scale depending on the capability of the backhaul (such as latency or capacity). With a relatively fast backhaul, messaging between eNBs cbe considered. Messaging between eNBs such as to implement the partitioning as described in inter-eNB CA for simultaneous PUCCH and PUSCH transmissions, based on interference management and/or traffic adaptation (such as IMTA) or to change the SCellIndex value assignment as described in inter-eNB coordination with SCellIndex values based on SCell activation/deactivation status. For example, when an Scell is activated, the activating eNB may send an X2 message to the other eNB indicating a new preferred subframe partition. The same scenario may be true in the case of deactivation as well. In some embodiments, instead of directly indicating the subframes, sets of configuration indices (similar to DL/UL configurations in TDD) may be used to reduce message overhead in a similar way as illustrated in Table 4.

In some embodiments, various functions described above (such as the various eNB coordination methods) are implemented or supported by computer programs, each of which is formed from computer readable program code and embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

None of the description in this application should be read as implying that any particular element, step, or function is an essential element that must be included in the claim scope: the scope of patented subject matter is defined only by the claims. Moreover, none of these claims is intended to invoke paragraph six of 35 USC §112 unless the exact words “means for” are followed by a participle.

What is claimed is:

1. For use in a wireless network, a user equipment (UE) configured to communicate with a plurality of eNodeBs (eNBs), wherein each of the plurality of eNBs are configured to receive coordination information identifying how Uplink Control Information (UCI) data should be transmitted, the UE comprising processing circuitry;
wherein the processing circuitry is not configured for simultaneous Physical Uplink Control Channel (PUCCH) and Physical Uplink Shared Channel (PUSCH) transmissions when the UE is configured with more than one serving cell for inter-eNB Carrier Aggregation (CA).

2. A method of setting up a user equipment (UE) in an inter-eNodeB (eNB) Carrier Aggregation (CA) system, the method comprising:
not configuring, by an eNB, the UE for simultaneous Physical Uplink Control Channel (PUCCH) and Physical Uplink Shared Channel (PUSCH) transmissions; and
transmitting coordination information from at least one eNB to at least one other eNB so that the UE does not receive or transmit simultaneous PUCCH and PUSCH transmissions.

3. The method of claim 2, further comprising:
receiving at least one of Uplink Control Information (UCI) data and Uplink (UL) data from the user equipment.

4. The method of claim 3, where at least one of the UCI data and the UL data are received by a specified eNB from the user equipment via a frequency associated with the specified eNB.

5. For use in a wireless network, an eNodeB (eNB) configured to communicate with at least one user equipment (UE) and to receive coordination informing identifying how Channel State Information (CSI) should be transmitted, the eNB comprising processing circuitry;
wherein the processing circuitry is configured to receive control information comprising a partitioning of subframes so that no two aperiodic CSI report requests from two or more eNBs are sent to a UE in the same subframe.

6. The eNB of claim 5, wherein the eNB is configured to receive and transmit coordination information via one or more X2 messages.

7. The eNB of claim 5, wherein the eNB is configured to receive coordination information via a central entity.

8. The eNB of claim 5, wherein the partitioning of subframes between the two or more eNBs is based on an amount of path loss between each of the two or more eNBs and the UE.

9. The eNB of claim 5, wherein the partitioning of subframes between the two or more eNBs is based on a QoS requirement of bearer type set up between each of the two or more eNBs and the UE.

10. The eNB of claim 5, wherein the partitioning of subframes between the two or more eNBs is based on an amount of data traffic between each of the two or more eNBs and the UE.

11. The eNB of claim 5, wherein each of the two or more eNBs has a plurality of carriers that can be aggregated for the UE.

12. The eNB of claim 5, wherein a first of the two or more eNBs has a plurality of carriers that can be aggregated for the UE while a second of the two or more eNBs has only one carrier that can be aggregated for the UE.

13. A method of setting up an eNodeB (eNB) in an inter-eNB Carrier Aggregation (CA) system, the method comprising:
receiving and transmitting, by the eNB, control information comprising a partitioning of subframes so that no two aperiodic CSI report requests from two or more eNBs are sent to the user equipment in the same subframe.

14. For use in a wireless network, a first eNodeB (eNB) configured to participate with at least a second eNB in inter-eNB Carrier Aggregation (CA) and to receive and transmit coordination information identifying how hybrid automatic repeat requests and acknowledgments (HARQ-ACKs) should be transmitted, the first eNB comprising processing circuitry;
wherein the processing circuitry is configured to coordinate a first set of eNB subframe indices with at least a second set of eNB subframe indices such that the set of subframe indices for HARQ-ACK receptions by the first eNB does not overlap with the set of subframe indices for HARQ-ACK receptions by the second eNB.

15. The first eNB of claim 14, wherein the first eNB is configured to receive and transmit coordination information via one or more X2 messages.

16. The first eNB of claim 14, wherein the first eNB is configured to receive coordination information via a central entity.

17. The first eNB of claim 14, wherein the processing circuitry is configured to coordinate the first set of eNB subframe indices with at least the second set of eNB subframe indices by coordinating subframe indices for PUSCH receptions.

18. A method of setting up an eNodeB (eNB) in an inter-eNB Carrier Aggregation (CA) system, the method comprising:
transmitting and receiving control information by the eNB, wherein the control information comprises a partitioning subframes so that no two downlink (DL) assignments or uplink (UL) grants from two or more eNBs are sent to a user equipment (UE) in the same subframe.

19. A method of setting up an eNodeB (eNB) in an inter-eNB Carrier Aggregation (CA) system, the method comprising:
receiving and transmitting, by the first eNB, control information comprising coordinating information coordinating a first set of eNB subframe indices with at least a second set of eNB subframe indices such that the first set of subframe indices for HARQ-ACK receptions by the first eNB does not overlap with the second set of subframe indices for HARQ-ACK receptions by the second eNB.

20. A system for use in a wireless network, the system comprising:
a first eNodeB (eNB) configured to participate with at least a second eNB in inter-eNB Carrier Aggregation (CA) and to receive coordination information identifying how SCellIndex values should be assigned to one or more SCells associated with the first eNB or one or more SCells associated with the second eNB, the first eNB comprising processing circuitry;
wherein the processing circuitry is configured to assign a smallest SCellIndex value to an SCell of the first eNB when the first eNB detects that the second eNB controls a PCell.

21. The system of claim 20, wherein, when the first eNB and the second eNB are participating in inter-eNB CA, the first eNB and the second eNB are configured to coordinate the SCellIndex values by requiring the second eNB controlling the PCell and one or more SCells to assign SCellIndex values to its one or more SCells that are larger than any SCellIndex value assigned to any SCell of the first eNB.

22. The system of claim 20, wherein the first eNB is configured to schedule Uplink (UL) control and data transmissions for its one or more SCells without requiring PUCCH in a UL subframe.
